(19) United States
(12) Patent Application Publication
(10) Pub. No.: US 2016/0379323 A1
(43) Pub. Date: Dec. 29, 2016

(54) BEHAVIORAL AND EXOGENOUS FACTOR ANALYTICS BASED USER CLUSTERING AND MIGRATION

(71) Applicant: International Business Machines Corporation, Armonk, NY (US)

(72) Inventors: Raphael Ezry, New York, NY (US); Munish Goyal, Armonk, NY (US); Gareth J. Mitchell-Jones, Buckinghamshire (GB); Steven G. Pinchuk, Boynton Beach, FL (US)

(73) Assignee: International Business Machines Corporation, Armonk, NY (US)

(21) Appl. No.: 14/751,210

(22) Filed: Jun. 26, 2015

(51) Int. Cl. G06Q 50/18; G06Q 40/04; G06Q 30/02

(52) U.S. Cl. CPC G06Q 50/188; G06Q 30/0201; G06Q 40/04

(57) ABSTRACT

A present risk aversion of a customer is determined. A temporal preference is detected using historical data related to the customer, the temporal preference showing a preference of current utility over a future utility of a product. Using the temporal preference and a negative transaction risk, a future risk aversion of the customer is projected at a future time. A pattern of offer acceptance by the customer is identified in the historical data. A value of an exogenous factor is determined on which a buying ability of the customer depends. The customer is classified in a cluster, where all customers in the cluster have the present risk aversion, the temporal preference, the negative transaction risk, the future risk aversion, and the value. An offer for a product is presented to the cluster, which satisfies the present risk aversion, and where a probability of acceptance of the offer exceeds a threshold.

### TECHNICAL FIELD

The present invention relates generally to a method, system, and computer program product for selectively offering products and services to customers. More particularly, the present invention relates to a method, system, and computer program product for behavioral and exogenous factor analytics based user clustering and migration.

### BACKGROUND

Goods and services are collectively referred to as “product” or “products” unless expressly distinguished where used. A business typically has many products to offer their customers. Presently, businesses decide which products should be offered to a customer depends upon the customer's demographic profile, the business' location, and other regional, demographic, and economic factors. In some cases, a business considers the products that a customer has bought or used previously, and offers a product that matches or complements the previous purchases.

### SUMMARY

The illustrative embodiments provide a method, system, and computer program product for behavioral and exogenous factor analytics based user clustering and migration. An embodiment includes a method for behavioral and exogenous factor analytics based user clustering and migration. The embodiment determines, using a processor and a memory, a present risk aversion of a customer. The embodiment detects a temporal preference using historical data related to the customer, the temporal preference showing a preference of current utility over a future utility of a product. The embodiment projects, using the temporal preference and a negative transaction risk, a future risk aversion of the customer at a future time. The embodiment identifies a pattern of offer acceptance by the customer in the historical data. The embodiment determines a value of an exogenous factor on which a buying ability of the customer depends. The embodiment classifies the customer in a cluster, wherein all customers in the cluster have the present risk aversion, the temporal preference, the negative transaction risk, the future risk aversion, and the value of the exogenous factor. The embodiment presents an offer for a product to the cluster, wherein the product satisfies the present risk aversion, and wherein a probability of acceptance of the offer exceeds an offer probability threshold.

Another embodiment includes a computer program product for behavioral and exogenous factor analytics based user clustering and migration, the computer program product comprising one or more computer-readable storage devices, and program instructions stored on at least one of the one or more storage devices.

Another embodiment includes a computer system for behavioral and exogenous factor analytics based user clustering and migration, the computer system comprising one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a configuration for behavioral and exogenous factor analytics based user clustering and migration in accordance with an illustrative embodiment;

FIG. 4 depicts a block diagram of an example manner of forming customer clusters in accordance with an illustrative embodiment;

FIG. 5 depicts a flowchart of an example process for behavioral and exogenous factor analytics based user clustering and migration in accordance with an illustrative embodiment; and

FIG. 6 depicts a flowchart of an example process for offer optimization in accordance with an illustrative embodiment.

### DETAILED DESCRIPTION

Examples of any particular industry, such as the banking industry, are used only to describe the operations of the various embodiments and not to imply a limitation on the illustrative embodiments. An embodiment can be applied to any business that offers any type of products to a customer. Within the scope of an illustrative embodiment, a customer is a user who may be a human individual or another business.

The illustrative embodiments recognize that customers exhibit certain traits or behaviors that are not presently accounted for in product offers. For example, the illustrative embodiments recognize that a customer is inherently risk averse in the customer's buying behavior, and different customers are risk averse to different degrees towards different types of risks.

As an example, the illustrative embodiments recognize that a customer can be selective about certain products or types of products. By selecting certain products or types of products over others due to perceptions formed from learning about the product performance and other influences, the customer exhibits an aversion to an actual or a perceived risk with the products or types of products that the customer does not select.

Similarly, the illustrative embodiments recognize that a customer's pattern of product selections over time can be indicative of a customer's temporal preferences. One Customer may prefer borrowing money to consume the product today whereas another customer may prefer to wait for the right time for consuming the product. Customers' behaviors vary on the degree or the order of their temporal consumption preferences. Using this quantitative measure about a customer's temporal preferences, a reasonable projection can be made as to what the customer's product choices will be in the future.

The illustrative embodiments further recognize that not only the risk aversion, but many other factors also drive a customer's buying behavior. For example, a customer prefers certain products or types of products for their utility. In other words, a utility of a product to a customer predominantly contributes to the selection of the product by the customer, with secondary consideration or no consideration to the customer's risk aversions.

As another example, a customer's buying behavior is influenced by exogenous factors that apply to the customer. For example, a customer's profession contributes economic exogenous factors with the rise and fall of economic conditions in that profession. Consequently, the customer's buying behavior changes due to such factors. As another example, a customer's social participation contributes a different type of social exogenous factors. For example, the behavior of a social group in which the customer participates may change over a period influenced by a variety of reasons. Consequently, the social behavior of the group contributes social exogenous factors, which affect the customer's buying behavior.

Similarly, cultural, political, and many other aspects of a customer's environment contribute exogenous factors that affect the customer's buying behavior. These examples of exogenous factors are not intended to be limiting. From this disclosure, those of ordinary skill in the art will be able to conceive many other types of exogenous factors and the same are contemplated within the scope of the illustrative embodiments.

The illustrative embodiments recognize that the presently used methods for offering products to customers fail to consider such factors, and therefore fail to achieve optimal levels of offer acceptance by customers. Therefore, a method for behavioral and exogenous factor analytics based user clustering and migration is needed and will be useful in improving the selection of offers, the relevance of the offers to the customers, the offer acceptances, and consequently the profitability of the businesses.

The illustrative embodiments used to describe the invention generally address and solve the above-described problems and other problems related to offering products to customers. The illustrative embodiments provide a method, system, and computer program product for behavioral and exogenous factor analytics based user clustering and migration.

An embodiment defines clusters of customers. The clustering process uses four determining factors to assign a customer to a cluster. One determining factor for the clustering uses the present risk aversions. An embodiment further quantifies the present risk aversions into a present level of risk. The present risk aversions common to several customers form one basis for clustering customers and selecting the products that are offered those customers. The embodiment determines a temporal progression of the customer's present risk aversions and determines the progressed risk aversions at one or more times in the future. One embodiment quantifies the future risk aversions into a future level of risk.

Another determining factor for the clustering uses the temporal preferences. The embodiment determines a relative importance or utility of buying the product today versus postponing the buying decision to a future time period. One embodiment quantifies the temporal preference into a temporal preference metric, e.g., a degree of the temporal preference.

The temporal preference metrics are usable to determine which products to offer to the customer at the present time. For example, a business can determine whether the business can offer a loss-leading or low profitability product to a customer now such that the customer will eventually buy a high-yield product according to the customer's future risk aversions. Thus, the future risk aversions common to several customers form another basis for clustering customers and selecting the products that are offered those customers.

Another determining factor is the transaction volatility. Transaction volatility is measured by the negative transactions by the customer, such as multiple instances of product returns or large amount of withdrawals from a deposit account resulting in losses to the business. One embodiment quantifies the transaction volatility for a customer. The transaction volatility of a customer is also usable for clustering the customer with other customers who have a similar degree of volatility.

A business has to determine the effectiveness of the various offers it makes for various products to various customers. An embodiment uses a probability distribution model to compute a probability of success, to wit, acceptance, for a set of offers. The embodiment selects an offer in accordance with the given probability distribution from among a subset of those offers whose probability exceeds a threshold probability. The embodiment tests or explores the probability of acceptance of different selected offers with different portion of a cluster of customers. Depending upon the acceptance of an offer by a respective portion of a cluster, the embodiment revises a probability of acceptance associates with the offer.

The embodiment computes revised probabilities of success for each selected offer in this manner. The embodiment chooses those offers whose revised probabilities exceed a second threshold. The embodiment offers one or more of the chosen offers to a cluster using this revised probability distribution.

Testing an offer with an entire cluster can be wasteful because the cluster characteristics are expected to be homogeneous. Therefore, testing an offer with a portion of a cluster is representative of how the offer will perform with the cluster as a whole.

Furthermore, an offer for a product may perform differently in different clusters. An offer that is accepted with a probability greater than the second threshold in one cluster may not be accepted as much in a second cluster, and therefore may not be chosen for presenting to the second cluster. Operating in this manner, an embodiment operates to explore the probabilities of success of the various offers within various clusters, and then exploits, or uses, the learned behavior of the cluster towards the exploratory offer to selectively present only those offers whose probability of acceptance exceeds a business' desired threshold acceptance probability. Exploration of the offers in the set of offers helps an embodiment to learn which offers works best for the customer. Judicious selection of offers for exploration avoids wasteful use of a business' resources. An embodiment balances the benefits of the exploration of new offers with productive use of the resource for doing so, such as by selecting offers according to probability thresholds. The embodiment also presents, or exploits, those offers that have previously been learnt to yield the desired results, thereby maximizing the returns to the business and minimizing the cost of the expended resources.

When an offer is presented to a customer, the customer may or may not accept the offer. If the customer accepts the offer, the customer moves to a new cluster after having bought the product because the customer is unlikely to buy another instance of the same product. The customer's behavior may also diverge from the expected behavior of the customer's cluster. When this happens, an embodiment migrates or updates the customer to a different cluster that better matches the actual behavior of the customer or the new realized reality of the offer acceptance by the customer.

For example, the embodiment re-evaluates the present risk aversions based on the customer's actual divergent response to an offer, re-evaluates a future risk aversion, and determines any changes in the customer's exogenous factors reflected in the customer's divergent response to the offer. Based on the revised present risk aversions, future risk aversions, and exogenous factors, the embodiment determines a suitable new cluster for the customer. The new cluster may be different from the cluster to which the customer belonged when the offer was made. The embodiment migrates the customer to the new cluster.

A method of an embodiment described herein, when implemented to execute on a device or data processing system, comprises substantial advancement of the functionality of that device or data processing system in behavioral and exogenous factor analytics based user clustering and migration. For example, prior-art offers products to customer without regard to a customer's risk perceptions the probability of acceptance of an offer given those perceptions and exogenous factors. An embodiment categorizes customers into clusters of customers with similar present and future risk aversions and similar influences of exogenous factors. An embodiment then tests various offers with portions of such clusters to determine their probabilities of acceptance in those clusters. An embodiment selects those offers for presenting in a cluster, which are found to have at least a desired level of probability of success from such testing. Such a manner of behavioral and exogenous factor analytics based user clustering and migration is unavailable in presently available devices or data processing systems. Thus, a substantial advancement of such devices or data processing systems by executing a method of an embodiment improves the effectiveness of the offers, utility of the offered product to a customer, and the profitability of the business that offers the products.

The illustrative embodiments are described with respect to certain industries, products, offers, risks, risk aversions, probabilities, factors, clusters, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

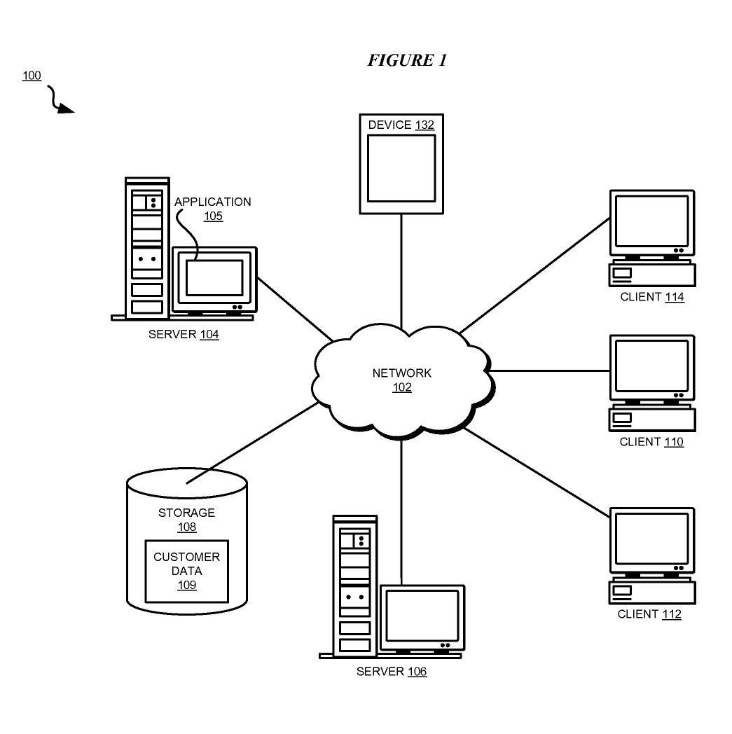

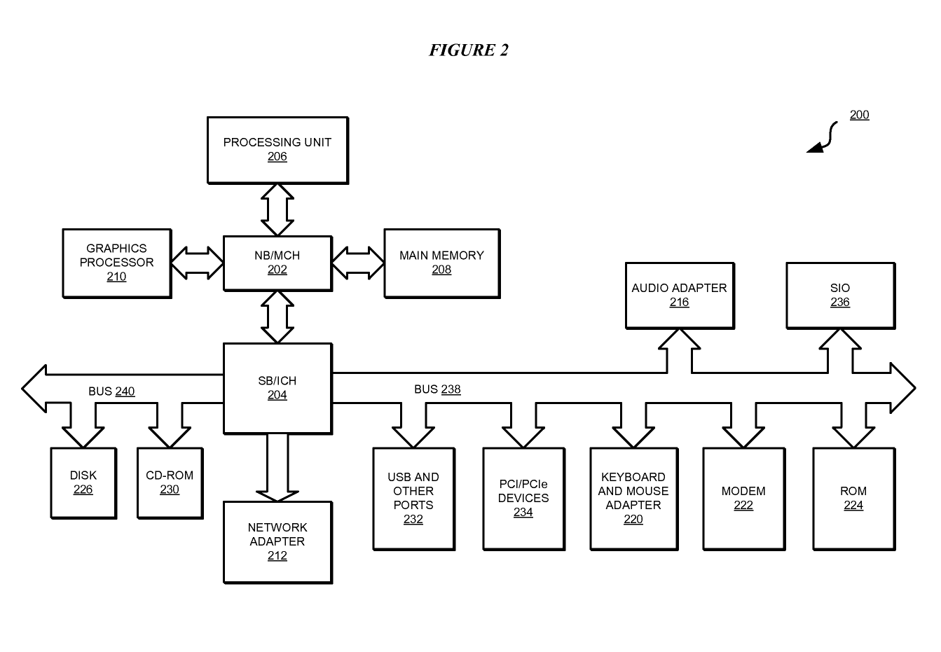

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Customer data 109 includes historical information about customers of a business. As some non-limiting examples, customer data 109 includes data of past purchases or transactions made by a customer; the customer's demographic, economic, professional, and other exogenous factors that can be considered by an embodiment; a previously computed present and/or future risk aversion or a quantified risk level; and the like. When a new customer's behavior has to be analyzed as described herein, and customer data 109 does not include data of the new customer, an embodiment selects the data of one or more existing customers who are similar to the new customer is some respect, and makes the initial behavior determination as described herein.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCl/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

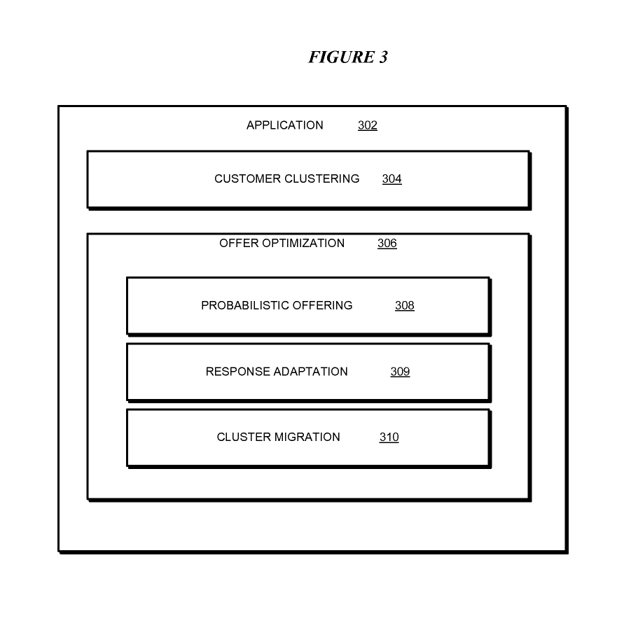

With reference to FIG. 3, this figure depicts a block diagram of a configuration for behavioral and exogenous factor analytics based user clustering and migration in accordance with an illustrative embodiment. Application 302 is an example of application 105 in FIG. 1.

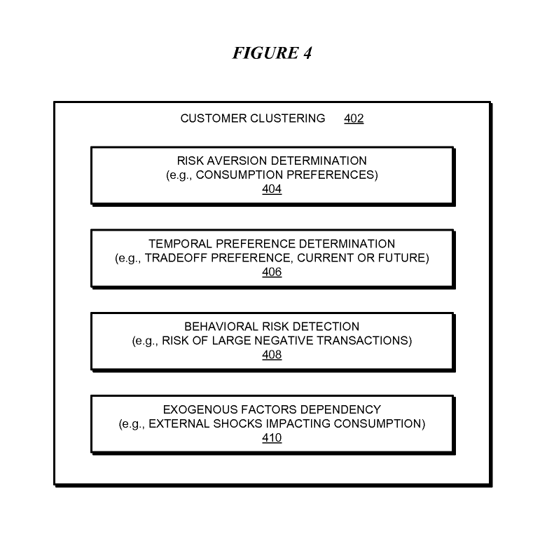

Component 304 uses customer data, such as customer data 109 in FIG. 1, to cluster the customers into various clusters. An example manner of clustering is described with respect to FIG. 4.

Component 306 performs offer optimization. Particularly, component 306 assigns probabilities of success to a set of offers, tests a subset of the offers using different portions of a cluster and similarly in different clusters, and revises the probabilities of acceptance of the tested offers according to actual acceptance in those portions of the clusters. Component 306 produces an offer with a revised probability of acceptance based on the exploratory test. Thus, component 306 optimizes a set of offers into a subset of those offers such that each offer in the subset has a greater-than-a threshold probability of being accepted by a customer in a cluster identified with the offer. Subcomponent 308 assigns probability to each offer for a cluster. The offers are made through probabilistic sampling of an offer from the offer set using the assigned probability distributions where the probability exceeds certain threshold.

Subcomponent 309 adapts these probabilities based on a customer's response to the offer. For example, subcomponent 309 adjusts the probability associated with an offer based on whether the customer accepts the offer. If the customer accepts the offer, subcomponent 309 increases the probability value for the offer. Subcomponent 309 decreases the probability when the customer rejects the offer. In an exploration mode of component 306, subcomponent 309 can also present offers with zero probability or lower-that-a-threshold probability value to learn the customer's response behavior.

Having learned the offer response behavior of a customer for a period of sufficient duration, component 306 switches to an exploitation mode. In the exploitation mode, subcomponent 309 presents those offers to the customers where probabilities of acceptance are above a predetermined threshold.

Subcomponent 310 determines whether a customer's buying behavior is consistent with, or deviant from, an expected behavior in the cluster. Particularly, subcomponent 310 uses the actual acceptance data collected by subcomponent 309 to make this determination. When a customer's actual buying behavior deviates from the expected behavior in the cluster, subcomponent 310 migrates the customer to a new or different cluster as described herein.

With reference to FIG. 4, this figure depicts a block diagram of an example manner of forming customer clusters in accordance with an illustrative embodiment. Customer clustering component 402 is an example of component 304 in FIG. 3.

Subcomponent 404 determines the present risk aversions of a customer. Subcomponent 404 uses customer data 109 in FIG. 1 to make this determination. The data used may be of the customer or a similar customer. Subcomponent 404 quantifies the present risk aversions into a risk value, e.g., a present risk level tolerated by the customer. An output of component 404 helps determine a product that can be presently offered to the customer consistent with the customer's present risk aversions.

Subcomponent 406 quantifies the future risk aversions into a risk value, e.g., a risk level projected to be tolerated by the customer at a future time. An output of component 406 helps determine a product that can be presently offered to the customer presently such that the presently offered product and a product offered in the future can together satisfy a business objective, e.g., profitability of the customer to the business.

Subcomponent 406 projects the temporal preferences of a customer over a period. Subcomponent 406 uses customer data 109 in FIG. 1 to make this determination. The data used may be of the customer or a similar customer. Subcomponent quantifies the degree of temporal preference as described elsewhere in this disclosure. The output of subcomponent 406 helps determine customer's preference about buying a product when offered, or a preference for waiting to buy the product at a later time. The risk factor and product preferences give appropriate weight to the customer's decision making process for maximizing the gross utility from buying the product.

Subcomponent 408 determines a pattern of behavioral risks of the customer, e.g., the risk of a large negative transaction by the customer. Subcomponent 408 uses customer data 109 in FIG. 1 to make this determination. The data used may be of the customer or a similar customer. As an example, Markov chain model is a well known technique for pattern detection, and can be implemented in subcomponent 408 for pattern detection in customer data 109.

Subcomponent 410 selects a set of exogenous factors applicable to a customer according to a set of defined rules or business logic. Subcomponent 410 determines or assigns values to each of the exogenous factors in the set of factors of a customer according to the customer's particular profile.

Component 304 in FIG. 3 uses the computed risk aversions, the exogenous factor values, and the offer response behavior of the customer to select a cluster whose risk aversions, exogenous factors, and buying behavior match those of the customer at least to a threshold degree. Component 304 in FIG. 3 classifies the customer into the selected cluster.

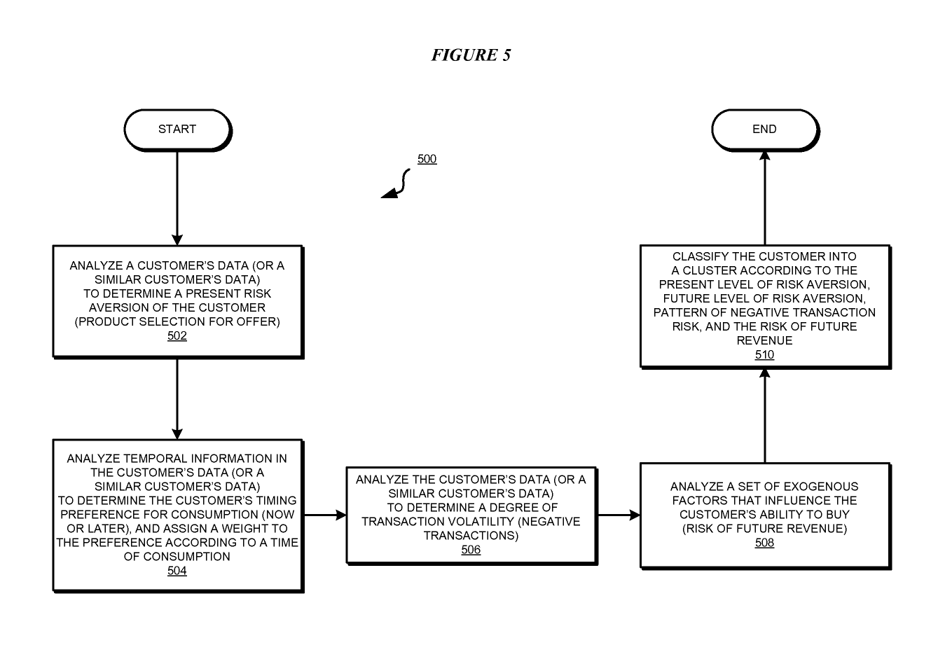

With reference to FIG. 5, this figure depicts a flowchart of an example process for behavioral and exogenous factor analytics based user clustering and migration in accordance with an illustrative embodiment. Process 500 can be implemented in application 302 in FIG. 3.

The application analyzes a customer's data of a customer, or the customer data of a similar customer, to determine a present risk aversion (block 502). The application analyzes a temporal information in the customer's data, or in a similar customer's data, to determine the customer's timing preference, e.g., a preference to buy now versus a preference to wait and buy in the future (block 504). In block 504, the application quantifies such temporal preference into a degree of temporal preference according to the preferred time of the consumption.

The application analyzes a pattern of transaction volatility, e.g., negative transactions, in the customer's data, or in a similar customer's data (block 506). In block 506, the application quantifies such transaction volatility into a degree of transaction volatility according to an amount, frequency, or both, of the negative transactions.

The application analyzes a set of exogenous factors that influence the customer's ability in general, the ability to buy a type of product in particular, or both (block 508). Some non-limiting examples of the exogenous factors and their influences are described in this disclosure.

The application classifies the customer into a cluster according to the analyses of blocks 502, 504, 506, and 508 (block 510). The application ends process 500 thereafter.

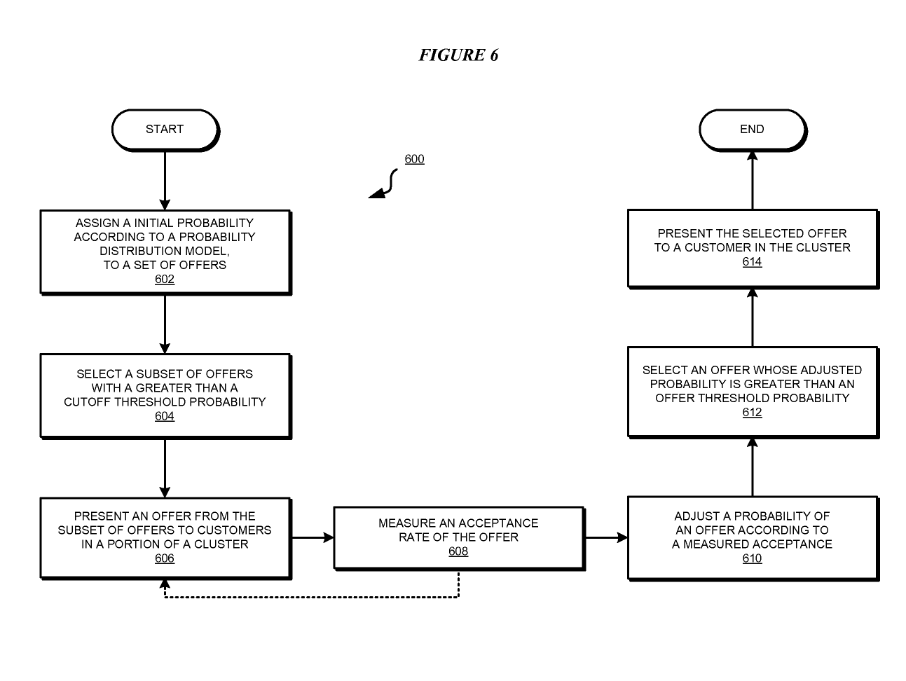

With reference to FIG. 6, this figure depicts a flowchart of an example process for offer optimization in accordance with an illustrative embodiment. Process 600 can be implemented in application 302 in FIG. 3.

The application assigns an initial probability according to a probability distribution model, to a set of offers (block 602). The application selects a subset of offers whose initial probabilities are greater than a cutoff threshold (block 604).

The application presents an offer from the subset to the customers in a portion of a cluster (block 606). The application measures an actual acceptance rate, i.e., number of acceptance versus non acceptance, of the offer (block 608). The application repeats block 606 and 608 for different offers in the subset, and with different portions in a cluster.

The application adjusts an initial probability of an offer according to the acceptance rate of the offer in a portion of the cluster (block 610). The application selects an offer whose adjusted probability of acceptance is greater than an offer threshold probability (block 612). The application presents the selected offer to a customer in the cluster (block 614). The application ends process 600 thereafter.

Thus, a computer implemented method, system or apparatus, and computer program product are provided in the illustrative embodiments for behavioral and exogenous factor analytics based user clustering and migration. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for behavioral and exogenous factor analytics based user clustering and migration, the method comprising:
determining, using a processor and a memory, a present risk aversion of a customer;
detecting a temporal preference using historical data related to the customer, the temporal preference showing a preference of current utility over a future utility of a product;
projecting, using the temporal preference and a negative transaction risk, a future risk aversion of the customer at a future time;
identifying a pattern of offer acceptance by the customer in the historical data;
determining a value of an exogenous factor on which a buying ability of the customer depends;
classifying the customer in a cluster, wherein all customers in the cluster have the present risk aversion, the temporal preference, the negative transaction risk, the future risk aversion, and the value of the exogenous factor; and
presenting an offer for a product to the cluster, wherein the product satisfies the present risk aversion, and wherein a probability of acceptance of the offer exceeds an offer probability threshold.

2. The method of claim 1, further comprising:
assigning, according to a probability distribution model, a corresponding initial probability of acceptance to each offer in a set of offers;
presenting a first offer from the set of offers to a first portion of the cluster and a second offer from the set of offers to a second portion of the cluster;
measuring a first rate of acceptance of the first offer by the first portion and a second rate of acceptance of the second offer by the second portion;
adjusting a first initial probability of acceptance of the first offer to a first adjusted probability of acceptance using the first rate of acceptance of the first offer by the first portion;
adjusting a second initial probability of acceptance of the second offer to a second adjusted probability of acceptance using the second rate of acceptance of the second offer by the second portion;
determining that the first adjusted probability of acceptance exceeds the offer probability threshold;
determining that the second adjusted probability of acceptance does not exceeds the offer probability threshold; and
selecting the first offer as the offer for the product.

3. The method of claim 2, further comprising:
selecting a subset of offers wherein each offer in the subset has a corresponding initial probability of acceptance exceeding a cutoff threshold probability, the subset of offers includes the first offer and the second offer.

4. The method of claim 2, further comprising:
selecting, to explore acceptability in a cluster, a subset of offers wherein each offer in the subset has a corresponding initial probability of acceptance below a cutoff threshold probability, the subset of offers includes the first offer and the second offer.

5. The method of claim 2, further comprising:
selecting a sampling of offers wherein an offer in the sampling has an initial probability of acceptance, and the initial probability of acceptance is representative of a sample probability of acceptance.

6. The method of claim 1, further comprising:
determining, as a part of determining the present risk aversion, using the historical data, a product type to which the customer is averse, wherein the product is of a type other than the product type to which the customer is averse.

7. The method of claim 1, wherein the historical data is data of a second customer, the second customer having a second present risk aversion that is similar to the present risk aversion of the customer.

8. The method of claim 1, further comprising:
identifying, using the future risk aversion of the customer, a future product to offer the customer at the future time; and
selecting the offer for the product by determining that a sale of the product and a sale of the future product together satisfy a profitability threshold.

9. The method of claim 1, wherein the exogenous factor is a social factor, wherein the social factor is indicative of a preference of a social group in which the customer participates.

10. The method of claim 1, wherein the exogenous factor is a professional factor, wherein the professional factor is indicative of an economic stability of a profession in which the customer participates.

11. The method of claim 1, wherein the exogenous factor is indicative of a risk in selling a future product to the customer.

12. The method of claim 1, further comprising:
evaluating a response of the customer to the offer for the product;
determining that the response is different from a response expected from the customers in the cluster;
recomputing (i) the present risk aversion, (ii) the future risk aversion, (iii) the pattern of offer acceptance, and (iv) the value of the exogenous factor to at least one of (i) a revised present risk aversion, (ii) a revised future risk aversion, (iii) a revised pattern of offer acceptance, and (iv) a revised value of the exogenous factor, respectively;
migrating the customer to a second cluster, wherein all customers in the cluster have the revised present risk aversion, the revised future risk aversion, the revised pattern of offer acceptance, and the revised value of the exogenous factor.

13. The method of claim 1, wherein the method is embodied in a computer program product comprising one or more computer-readable storage devices and computer-readable program instructions which are stored on the one or more computer-readable tangible storage devices and executed by one or more processors.

14. The method of claim 1, wherein the method is embodied in a computer system comprising one or more processors, one or more computer-readable memories, one or more computer-readable storage devices and program instructions which are stored on the one or more computer-readable storage devices for execution by the one or more processors via the one or more memories and executed by the one or more processors.

15. A computer program product for behavioral and exogenous factor analytics based user clustering and migration, the computer program product comprising one or more computer-readable storage devices, and program instructions stored on at least one of the one or more storage devices, the stored program instructions comprising:
program instructions to determine, using a processor and a memory, a present risk aversion of a customer;
program instructions to detect a temporal preference using historical data related to the customer, the temporal preference showing a preference of current utility over a future utility of a product;
program instructions to project, using the temporal preference and a negative transaction risk, a future risk aversion of the customer at a future time;
program instructions to identify a pattern of offer acceptance by the customer in the historical data;
program instructions to determine a value of an exogenous factor on which a buying ability of the customer depends;
program instructions to classify the customer in a cluster, wherein all customers in the cluster have the present risk aversion, the temporal preference, the negative transaction risk, the future risk aversion, and the value of the exogenous factor; and
program instructions to present an offer for a product to the cluster, wherein the product satisfies the present risk aversion, and wherein a probability of acceptance of the offer exceeds an offer probability threshold.

16. The computer program product of claim 15, further comprising:
program instructions to assign, according to a probability distribution model, a corresponding initial probability of acceptance to each offer in a set of offers;
program instructions to present a first offer from the set of offers to a first portion of the cluster and a second offer from the set of offers to a second portion of the cluster;
program instructions to measure a first rate of acceptance of the first offer by the first portion and a second rate of acceptance of the second offer by the second portion;
program instructions to adjust a first initial probability of acceptance of the first offer to a first adjusted probability of acceptance using the first rate of acceptance of the first offer by the first portion;
program instructions to adjust a second initial probability of acceptance of the second offer to a second adjusted probability of acceptance using the second rate of acceptance of the second offer by the second portion;
program instructions to determine that the first adjusted probability of acceptance exceeds the offer probability threshold;
program instructions to determine that the second adjusted probability of acceptance does not exceeds the offer probability threshold; and
program instructions to select the first offer as the offer for the product.

17. The computer program product of claim 16, further comprising:
program instructions to select a subset of offers wherein each offer in the subset has a corresponding initial probability of acceptance exceeding a cutoff threshold probability, the subset of offers includes the first offer and the second offer.

18. The computer program product of claim 16, further comprising:
program instructions to select, to explore acceptability in a cluster, a subset of offers wherein each offer in the subset has a corresponding initial probability of acceptance below a cutoff threshold probability, the subset of offers includes the first offer and the second offer.

19. The computer program product of claim 16, further comprising:
program instructions to select a sampling of offers wherein an offer in the sampling has an initial probability of acceptance, and the initial probability of acceptance is representative of a sample probability of acceptance.

20. A computer system for behavioral and exogenous factor analytics based user clustering and migration, the computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to determine, using a processor and a memory, a present risk aversion of a customer;
program instructions to detect a temporal preference using historical data related to the customer, the temporal preference showing a preference of current utility over a future utility of a product;
program instructions to project, using the temporal preference and a negative transaction risk, a future risk aversion of the customer at a future time;
program instructions to identify a pattern of offer acceptance by the customer in the historical data;
program instructions to determine a value of an exogenous factor on which a buying ability of the customer depends;
program instructions to classify the customer in a cluster, wherein all customers in the cluster have the present risk aversion, the temporal preference, the negative transaction risk, the future risk aversion, and the value of the exogenous factor; and
program instructions to present an offer for a product to the cluster, wherein the product satisfies the present risk aversion, and wherein a probability of acceptance of the offer exceeds an offer probability threshold.
